(19) United States
(12) Patent Application Publication
(10) Pub. No.: US 2022/0170422 A1
(43) Pub. Date: Jun. 2, 2022

(54) ENGINE TORQUE LIMIT CONTROL

(71) Applicant: Perkins Engine Company Limited, Peterborough (GB)

(72) Inventors: Nicholas TIMMINS, Perton (GB); James Pardoe, Telford (GB); Simaranjit Gill, Edgbaston (GB); Adam Turnock, Eccleshall (GB); Mark Harriott, Tean (GB)

(73) Assignee: Perkins Engine Company Limited, Peterborough (GB)

(21) Appl. No.: 17/539,712

(22) Filed: Dec. 1, 2021

(30) Foreign Application Priority Data
Dec. 1, 2020 (GB) 2018912.2

(51) Int. Cl. F02D 29/06; F02D 41/00

(52) U.S. Cl. CPC F02D 29/06; F02D 41/0007; F02D 2200/021; F02D 2200/1002; F02D 2250/26

(57) ABSTRACT

A method for controlling a torque limit of an engine, which includes activating a power boost mode in which an enhanced engine torque limit for the engine is temporarily enabled in place of a normal engine torque limit for the engine. In this way, on receipt of a transient load demand during an operational period of the power boost mode, a fuel rate of the engine may be increased to attempt to meet the transient load demand while maintaining an engine torque of the engine within the enhanced engine torque limit.

### TECHNICAL FIELD

The present disclosure relates to a method for controlling a torque limit of an engine and to an engine and genset embodying the method.

### BACKGROUND TO THE DISCLOSURE

An internal combustion engine (ICE) may be configured as a fixed speed engine that is configured with a desired rated engine speed when running. Fixed speed engines have various uses. One use is as part of a genset, wherein an engine is combined with an electric generator for generating electrical energy. A genset may be used to provide additional power or backup power for an installation.

In a fixed speed engine the engine speed may be maintained at a desired engine speed by an engine governor. During transient load steps on the engine, the engine governor maintains rated speed. For example, when the actual engine speed differs from the desired (rated) engine speed, the engine governor may make fuel changes to return the actual engine speed to the desired engine speed.

However, if the size of a transient load applied to the engine is at or near 100% of the rated load of the engine it can be very difficult for the engine governor to control the engine with no extra fuel available to it, for example due to regulatory impacts on the torque limit of the engine, or to recover engine speed if the actual engine speed is below the desired engine speed during a load step. This is especially true when the engine speed is close to the desired (rated) engine speed and there is little to no voltage drop from the generator.

It is undesirable for a fixed speed engine to take too long to return to its rated speed. For example, some jurisdictions impose regulatory requirements including transient load acceptance tests, for example, ISO8528 and National Fire Protection Association (NFPA) requirements. These tests may be failed where a fixed speed engine takes too long to return to its rated speed under a transient load step.

Coping with transient load steps may be more difficult where the engine is in a cold environment and or is operating below its peak operating temperature. Such conditions may be experienced, in particular, for genset engines which may often be sited outside (or with minimal thermal insulation) and required to operate periodically, respond quickly to power outages and may be activated more frequently in cold conditions (for example since power outages may be more common in winter months).

Before an engine reaches its peak operating temperature, additional fuel is required to pull an equivalent torque, due to increased frictional losses, and increased thermal losses in the engine. As a result, transient load acceptance recovery may be negatively impacted.

### SUMMARY OF THE DISCLOSURE

An aspect of the present disclosure provides a method for controlling a torque limit of an engine, the method comprising the steps of:
a) starting the engine;
b) increasing an engine speed of the engine up to a desired engine speed;
c) activating a power boost mode once an actual engine speed of the engine equals the desired engine speed, wherein, while the power boost mode is active, an enhanced engine torque limit for the engine is enabled in place of a normal engine torque limit for the engine;
d) initiating a run-timer to measure an operational period of the power boost mode;
e) on receipt of a transient load demand during the operational period of the power boost mode, increasing a fuel rate of the engine to attempt to meet the transient load demand while maintaining an engine torque of the engine within the enhanced engine torque limit; and
f) deactivating the power boost mode once the run-timer exceeds a pre-determined time threshold for the operational period.

Another aspect of the present disclosure provides an engine comprising a plurality of cylinders and a controller, the controller being enabled to control a torque limit of the engine;

the controller being configured to:
a) start the engine;
b) increase an engine speed of the engine up to a desired engine speed;
c) activate a power boost mode once an actual engine speed of the engine equals the desired engine speed, wherein, while the power boost mode is active, an enhanced engine torque limit for the engine is enabled in place of a normal engine torque limit for the engine;
d) initiate a run-timer to measure an operational period of the power boost mode;
e) on receipt of a transient load demand during the operational period of the power boost mode, increase a fuel rate of the engine to attempt to meet the transient load demand while maintaining an engine torque of the engine within the enhanced engine torque limit; and
f) deactivate the power boost mode once the run-timer exceeds a pre-determined time threshold.

Another aspect of the present disclosure provides a genset comprising the engine of the above embodiment and an electric generator for generating electrical energy.

### BRIEF DESCRIPTION OF THE DRAWINGS

One or more embodiments of the disclosure will now be described, by way of example only, with reference to the accompanying drawings in which:

FIG. 1 is a schematic flow chart of a control method according to an embodiment of the present disclosure; and

FIG. 2 is a schematic view of an engine and a controller for illustrating operation of the method.

### DETAILED DESCRIPTION

Unless defined otherwise, all technical and scientific terms used in this specification have the same meaning as is commonly understood by the reader skilled in the art to which the claimed subject matter belongs. It is to be understood that the foregoing summary of the disclosure and the following examples are exemplary and explanatory only and are not restrictive of any subject matter claimed.

The following description is directed to embodiments of the disclosure. The description of the embodiments is not meant to include all the possible embodiments of the disclosure that are claimed in the appended claims. Many modifications, improvements and equivalents which are not explicitly recited in the following embodiments may fall within the scope of the appended claims. Features described as part of one embodiment may be combined with features of one or more other embodiments unless the context clearly requires otherwise.

In this specification, the use of the singular includes the plural unless the context clearly dictates otherwise. In this application, the use of “and/or” means “and” and “or” unless stated otherwise.

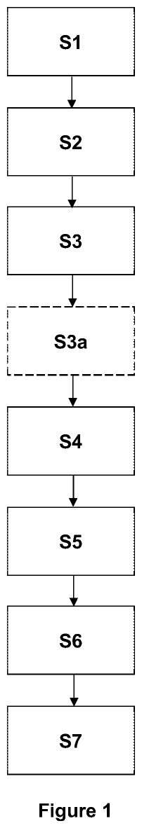

FIG. 1 shows a flow chart illustrating a control method for an engine. The method may be applied to the engine to control the functioning of the engine.

The engine may form part of a machine or may be a stand-alone engine.

The engine may form part of generator, also referred to as a genset. The generator may be a stationary generator or mobile generator. The generator may be a standby generator. The generator may be used to generate electricity or electricity and useful heat in combination as part of a combined heat and power (CHP) generator. The engine may be a fixed-speed engine.

The engine may be or comprise an internal combustion engine (ICE). The ICE may use diesel as its primary fuel. The diesel may, for example, be conventional diesel or biodiesel.

The engine may have multiple cylinders. The engine may have 2 or more cylinders, optionally 4 or more cylinders, optionally 6 or more cylinders, optionally 8 or more cylinders, optionally 12 or more cylinders, optionally 16 or more cylinders, optionally 24 or more cylinders.

The engine may have a power density of greater than 20 bar gross BMEP, optionally greater than 28 bar gross BMEP, optionally greater than 30 bar gross BMEP.

The engine may have a cylinder displacement of 3 litres or more per cylinder. The engine may have an engine displacement of 23 litres or more, optionally 23 to 61 litres.

The engine may have a compression ratio of less than 14:1.

The engine may operate in conditions where an ambient temperature surrounding the engine is less than 10° C.

The method may be performed in whole or in part by operation of a controller. The controller may comprise hardware and/or software. The controller may comprise a control unit or may be a computer program running on a dedicated or shared computing resource. The controller may comprise a single unit or may be composed of a plurality of sub-units that are operatively connected. The controller may be located on one processing resource or may be distributed across spatially separate computing resources. The controller may comprise one or more programmable and or non-programmable memory units or sub-units. The controller may comprise data storage and handling units or sub-units. The controller may comprise or form part of an engine electronic control module (ECM) operatively connected to the engine.

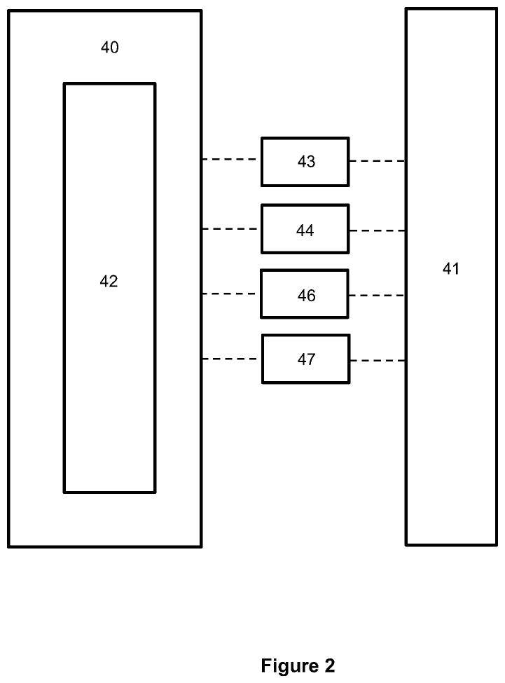

FIG. 2 shows a schematic view of an engine 40 and a controller 41 for illustrating operation of the method. The engine 40 may comprises a plurality of cylinders 42.

The controller 41 may utilise as part of the method one or more variables associated with operation of the engine 40. The variables may comprise one or more of an engine speed 43, an engine coolant temperature 44, an engine load factor 46, and an engine torque 47.

The engine 40 and/or controller 41 may comprise one or more associated sensors for detecting, determining, calculating or inferring the aforementioned variables. For example, one or more of an engine coolant temperature sensor, an engine intake manifold temperature sensor, an engine speed sensor, an engine manifold absolute pressure sensor, a throttle position sensor, an engine torque sensor, an air intake sensor, an air inlet temperature sensor (post any air filters), a fuel temperature/pressure into engine, a turbine inlet temperature (exhaust) and a barometric pressure sensor may be provided.

In particular, one or more engine speed sensors may be provided. For example, a primary engine speed sensor may monitor a crank shaft speed and position through a flywheel. Additionally or alternatively, a secondary engine speed sensor may monitor a camshaft speed and position through a camshaft gear.

In particular, the engine torque 47 may be measured directly by an engine torque sensor. Alternatively, engine torque 47 may be calculated or inferred from the measurement of other sensor inputs available to the controller 41. Engine torque 47 may be inferred from comparison of one or more sensor inputs to calibrated torque curves which are obtained during engine development, so as to avoid the need to provide a separate engine torque sensor. In one example, calibrated engine torque curve(s) are obtained using a load bank/torque ring during development. The load factor of the engine may be determined based on the fuel rate and torque/fuel limit setting that is applied.

At step S1 an engine start command may be provided. The engine start command may comprise actuation of a virtual or physical key, switch, button or other actuator. In some embodiments the engine start command may be provided by a key 50 that is used to operate an ignition controller. Starting of the engine 40 may be under the control of the controller 41.

At step S2 the engine speed of the engine 40 may be increased up to a desired engine speed.

Once the engine speed of the engine 40 equals the desired engine speed, at step S3 a power boost mode is activated. While the power boost mode is active, an enhanced engine torque limit for the engine 40 is enabled in place of a normal engine torque limit for the engine 40.

The enhanced engine torque limit may equal the normal engine torque limit of the engine 40 multiplied by a torque limit multiplier. The torque limit multiplier may be between 1.01 and 1.15. In some examples the torque limit multiplier may be 1.10.

The normal engine torque limit and the enhanced engine torque limit may comprise torque maps. The torque maps may each comprise a two dimensional map of engine torque vs. engine speed. The absolute values of permitted engine torque at each engine speed or within each engine speed band may be dependent on the rating of the engine. Where a torque map is used the torque limit multiplier may be all torque values of the torque map.

Optionally, the power boost mode may be activated only if a coolant temperature of the engine 40 is below a coolant temperature threshold. The coolant temperature threshold may be 0-120° C. In some examples the coolant temperature threshold may be 0-70° C.

A debounce timer may be applied to the coolant temperature threshold in step S3 such that the power boost mode is only activated if the coolant temperature of the engine 40 is below the coolant temperature threshold for a period of time. The period of the debounce timer may be selected, for example, from the range of 0-60 seconds.

At step S4 a run-timer is initiated to measure an operational period of the power boost mode. The run-timer may be initiated at the same time as the power boost mode is activated.

At step S5 a transient load demand is received by the engine 40. If the operational period of the power boost mode is still active, i.e. the run-timer is still running, then at step S6, a fuel rate of the engine is increased to attempt to meet the transient load demand while maintaining an engine torque of the engine 40 within the enhanced engine torque limit.

The transient load demand may be greater than 85%, optionally greater than 90%, optionally greater than 95%, optionally 100% of a rated load of the engine 40.

At step S7 the power boost mode is deactivated once the run-timer exceeds a pre-determined time threshold for the operational period. The pre-determined time threshold of the operational period may be 0-1500 seconds. In some examples the pre-determined time threshold of the operational period may be 120-600 seconds.

Optionally, once the run-timer exceeds the pre-determined time threshold and the power boost mode is deactivated, reactivation of the power boost mode may be prevented until the engine speed becomes zero, and preferably until the engine 40 is switched off and restarted.

Additionally or alternatively, the power boost mode may be deactivated in step S7 if the coolant temperature of the engine 40 exceeds the coolant temperature threshold. Thus, the power boost mode may be deactivated before the run-timer reaches the pre-determined time threshold if the coolant temperature of the engine 40 exceeds the coolant temperature threshold.

A debounce timer may be applied to the coolant temperature threshold in step S7 such that the power boost mode is only deactivated if the coolant temperature of the engine 40 exceeds the coolant temperature threshold for a period of time. The period of the debounce timer may be selected, for example, from the range of 0-60 seconds.

Optionally, the controller 41 may be configured at optional step S3a to prevent deactivation of the power boost mode for a delay period after its initiation irrespective of the engine coolant temperature. This may function to allow the engine conditions to settle, to allow time for coolant to flow through the engine 40, and/or to allow other processes of the engine and/or associated genset to finish. The delay period may be 0-300 seconds. Where a delay period is utilised, the run-timer may be initiated in step S4 after completion of the delay period of step S3a.

### INDUSTRIAL APPLICABILITY

The present disclosure may find application in controlling a torque limit of an engine.

Advantageously, the method permits a normal torque limit of the engine 40 to be temporarily exceeded in order to meet a transient load demand on the engine 40. In particular, the engine 40 may be permitted to temporarily use extra fuel to meet the transient load demand.

Beneficially, the additional transient load capacity of the engine 40 may mitigate issues such as operating in cold ambient conditions and where the engine 40 has not yet obtained its peak operating temperature. The method may also beneficially mitigate issues such as

engine-to-engine variability, generator efficiency variability, fan power variability, load bank measurement variability and natural derate.

Advantageously, the method may also beneficially mitigate issues when the transient load applied is large, for example where the transient load demand is greater than 85%, optionally greater than 90%, optionally greater than 95%, optionally 100% of a rated load of the engine 40. The method may find particular application with fixed-speed genset engines which may be required to operate intermittently and in cold ambient conditions and when called upon are often subjected to the application of large transient loads very soon after initial start-up when the engine 40 may still be operating below its peak operating temperature.

Beneficially, the use of the enhanced torque limit for the engine 40 is only temporary, and is prevented from running for too long by use of the run-timer. In addition, as soon as a sufficient engine operating temperature is obtained (as determined by measurement of the engine coolant temperature) the power boost mode may be deactivated. In these ways, the use of additional fuel can be minimised ensuring that the engine 40 maintains compliance with regulatory requirements.

1. A method for controlling a torque limit of an engine, the method comprising the steps of:
a) starting the engine;
b) increasing an engine speed of the engine up to a desired engine speed;
c) activating a power boost mode once an actual engine speed of the engine equals the desired engine speed, wherein, while the power boost mode is active, an enhanced engine torque limit for the engine is enabled in place of a normal engine torque limit for the engine;
d) initiating a run-timer to measure an operational period of the power boost mode;
e) on receipt of a transient load demand during the operational period of the power boost mode, increasing a fuel rate of the engine to attempt to meet the transient load demand while maintaining an engine torque of the engine within the enhanced engine torque limit; and
deactivating the power boost mode once the run-timer exceeds a pre-determined time threshold for the operational period.

2. The method of claim 1, wherein the pre-determined time threshold of the operational period is selected from the range of 0-1500 seconds, optionally selected from the range of 120-600 seconds.

3. The method of claim 1, wherein, in step c), the power boost mode is only activated if a coolant temperature of the engine is below a coolant temperature threshold.

4. The method of claim 1, wherein, in step f), the power boost mode is also deactivated if a coolant temperature of the engine exceeds a coolant temperature threshold.

5. The method of claim 3. wherein the coolant temperature threshold is selected from the range of 0-120° C., optionally selected from the range of 0-70° C.

6. The method of claim 3, wherein a debounce timer is applied to the coolant temperature threshold; and optionally wherein a period of the debounce timer is selected from the range of 0-60 seconds.

7. The method of claim 1, wherein the enhanced engine torque limit equals the normal engine torque limit of the engine multiplied by a torque limit multiplier.

8. The method of claim 7, wherein the torque limit multiplier is between 1.01 and 1.15, and optionally the torque limit multiplier is 1.10.

9. The method of claim 1, wherein the normal engine torque limit and the enhanced engine torque limit comprise torque maps.

10. The method of claim 1, wherein once the run-timer exceeds the pre-determined time threshold and the power boost mode is deactivated, reactivation of the power boost mode is prevented until the engine speed becomes zero, and preferably until the engine is switched off and restarted.

11. The method of claim 1, wherein in step e), the transient load demand is greater than 85%, optionally greater than 90%, optionally greater than 95%, optionally 100% of a rated load of the engine.

12. The method of claim 1, further comprising the step immediately after step c) of:
c2) preventing deactivation of the power boost mode for a delay period.

13. The method of claim 12, wherein the delay period is 0-300 seconds.

14. The method of claim 12, wherein the run-timer of step d) is initiated after completion of the delay period of step c2).

15. The method of claim 1, wherein the engine is a fixed-speed engine; optionally a fixed-speed genset engine; optionally a diesel fixed-speed genset engine.

16. The method of claim 1, wherein an ambient temperature surrounding the engine is less than 10° C.

17. An engine comprising a plurality of cylinders and a controller, the controller being enabled to control a torque limit of the engine;
the controller being configured to;
a) start the engine;
b) increase an engine speed of the engine up to a desired engine speed;
c) activate a power boost mode once an actual engine speed of the engine equals the desired engine speed, wherein, while the power boost mode is active, an enhanced engine torque limit for the engine is enabled in place of a normal engine torque limit for the engine;
d) initiate a run-timer to measure an operational period of the power boost mode;
e) on receipt of a transient load demand during the operational period of the power boost mode, increase a fuel rate of the engine to attempt to meet the transient load demand while maintaining an engine torque of the engine within the enhanced engine torque limit; and
f) deactivate the power boost mode once the run-timer exceeds a pre-determined time threshold.

18. The engine of claim 17, wherein the engine is a fixed-speed engine; optionally a fixed-speed genset engine; optionally a diesel fixed-speed genset engine.

19. A genset comprising an engine as claimed in claim 17 and an electric generator for generating electrical energy.
